(19) United States
(12) Patent Application Publication
(10) Pub. No.: US 2023/0150537 A1
(43) Pub. Date: May 18, 2023

(54) METHOD AND SYSTEM FOR ASSISTING WITH DRIVING

(71) Applicant: RENAULT S.A.S, Boulogne-Billancourt (FR)

(72) Inventor: Thierry GIACCONE, Fonsorbes (FR)

(73) Assignee: RENAULT S.A.S, Boulogne-Billancourt (FR)

(21) Appl. No.: 17/995,544

(22) PCT Filed: Mar. 25, 2021
(86) PCT No.: PCT/EP2021/057837

§ 371 Date: Oct. 5, 2022

(30) Foreign Application Priority Data
Apr. 6, 2020 (FR) 2003407

(51) Int. Cl. B60W 60/00; H04W 4/40; H04L 9/32

(52) U.S. Cl. CPC B60W 60/0011; B60W 60/0015; H04W 4/40; H04L 9/3236; B60W 2554/4046; B60W 2556/65; H04L 2209/84

(57) ABSTRACT

A method assists with driving a client vehicle upon detection of a current driving situation in a current time context. The method includes identifying a set of surrounding vehicles located in a neighboring area of the client vehicle; determining an identifier associated with each surrounding vehicle; transmitting a request for characterizing the driving behavior of each surrounding vehicle to a driving assistance server, the characterization request including the identifier associated with each surrounding vehicle, the current driving situation, and the current time context; determining a driving behavior score in association with each identifier using a database of driving behavior scores, with each driving behavior score in the database being associated with a vehicle identifier, in a given driving situation and in a given time context; and determining a driving maneuver as a function of the driving behavior scores associated with the identifiers of the surrounding vehicles.

### TECHNICAL FIELD

The invention generally relates to control systems and in particular to a driving assistance method and system for vehicles.

### PRIOR ART

Vehicle automation has experienced a significant upturn in recent years in order to improve road safety and to optimize vehicle driving. Automated or semi-automated vehicles, such as autonomous and connected vehicles, for example, use control systems to control the operation of the vehicle as a function of information measured by sensors onboard the vehicles.

Automated vehicles, such as autonomous and connected vehicles used in ITS (Intelligent Transport Systems) systems, are thus equipped with driving assistance systems such as ADAS (“Advanced driver-assistance systems”) systems or AD (“Autonomous Driving”) systems.

Such driving assistance systems can use various control applications such as an automatic lane change application for helping the driver to change lane, a lane keeping assistance application for detecting whether the vehicle accidentally crosses a lane marking, a cruise control (ACC) application and/or an impending collision warning application.

Cooperative intelligent transport systems implement connected vehicle infrastructure and devices in order to increase road safety and make transport safer, more efficient and more sustainable. Research on autonomous vehicles capable of moving from a point of departure to a point of arrival without driver intervention has also been actively conducted.

Autonomous vehicles can be required to make decisions that will allow the precise maneuvers to be established that are to be implemented in order to manage situations, called “negotiation situations”, such as getting a vehicle into a lane, joining a vehicle onto a highway or expressway, and entering a vehicle onto a roundabout. One of the problems of managing negotiation situations is anticipating the driving behavior of other cars in order to determine the most appropriate maneuver to be implemented as possible, while ensuring the safety of the vehicle and the compatibility of the maneuver with the road traffic that is encountered.

One technique for characterizing the driving behavior of the driver of a nearby vehicle has been proposed in U.S. Pat. No. 9,576,083 B2. This technique allows vehicles to be integrated into a network of autonomous vehicles by virtue of automatic modeling of the drivers. This technique is based on a computer-implemented method for identifying the types of behavior associated with driving a vehicle in the vicinity of an autonomous vehicle, in order to create a driving model relating to the driver. Behavior is identified by means of the various sensors on board the autonomous vehicle, such as cameras, ultrasonic sensors, and radar. The data gathered by these sensors are transmitted from the on-board computer of the autonomous vehicle to a remote server via a cellular network, in order to create a behavior model. The gathered data are associated with the license plate of the identified vehicle. The created behavior model is saved in the server and is used to update existing models previously saved in the server. On the server, the gathered data are associated with the license plate of each detected vehicle. The updated behavior model is then used by the autonomous vehicle, which will be able to make an appropriate maneuvering decision in the event of negotiation as a function of this driving behavior model.

Even though the existing driving assistance technologies improve driving comfort and provide driving assistance, these technologies have limitations and do not allow efficient and safe driving assistance, particularly for autonomous vehicles in negotiation situations.

A requirement therefore exists for a driving assistance method and system capable of assisting vehicles in negotiation situations, while reducing any collision risks and increasing the safety of the vehicle.

### General Definition of the Invention

The invention improves the situation. To this end, the invention provides a method for assisting with driving a client vehicle upon detection of a current driving situation in a current time context, particularly defined by date and time information, the method being characterized in that it comprises the following steps of:
identifying a set of surrounding vehicles located in a neighboring area of said client vehicle;
determining an identifier associated with each surrounding vehicle;
transmitting a request for characterizing the driving behavior of each surrounding vehicle to a driving assistance server, the characterization request comprising the identifier associated with each surrounding vehicle, the current driving situation, and the current time context;
determining a driving behavior score in association with each identifier using a database of driving behavior scores, with each driving behavior score in the database being associated with a vehicle identifier, in a given driving situation and in a given time context;
determining a driving maneuver as a function of the driving behavior scores associated with the identifiers of the surrounding vehicles.

In some embodiments, the identifier associated with each surrounding vehicle can be determined by applying a cryptographic function to a license plate number associated with the surrounding vehicle.

According to some embodiments, the database of driving behavior scores can comprise at least one strictly positive driving behavior score, the step of determining a driving behavior score including the following steps of:
determining the driving behavior score as being the behavior score saved in the database if a driving behavior score is associated therein with the identifier of said surrounding vehicle and with the current driving situation;
associating a predefined value with the driving behavior score if no driving behavior score is associated in the database with said identifier and with the current driving situation.

According to some embodiments, the client vehicle can be a connected vehicle having vehicle-to-vehicle communication technology and the set of surrounding vehicles can comprise at least one connected surrounding vehicle having vehicle-to-vehicle communication technology and vehicle-to-infrastructure communication technology, the method comprising a step of transmitting, by the connected surrounding vehicle to said client vehicle, a driving behavior score of said connected surrounding vehicle with a value different from said predefined value, using vehicle-to-vehicle communication.

According to some embodiments, the method can comprise a step of self-characterizing the connected surrounding vehicle in order to determine said driving behavior score in association with an identifier of said connected surrounding vehicle, the step of self-characterizing comprising the following sub-steps of:
determining an identifier associated with the connected surrounding vehicle by applying a cryptographic function to a license plate number associated with the connected surrounding vehicle;
transmitting a request for characterizing the driving behavior of the connected surrounding vehicle to the driving assistance server, the characterization request comprising the identifier associated with the connected surrounding vehicle, said current situation and said current time context;
determining a driving behavior score associated with said connected surrounding vehicle using said database.

According to some embodiments, the step of determining the driving behavior score associated with said connected surrounding vehicle can comprise the following steps of:
determining said driving behavior score as being the behavior score saved in said database if a driving behavior score is associated therein with said identifier of said connected surrounding vehicle and with the current situation;
associating a predefined value with said driving behavior score if no driving behavior score is associated in the database with said identifier and with the current driving situation.

According to some embodiments, the database can be previously determined, said database of driving behavior scores comprising at least one driving behavior score associated with an identifier relating to a vehicle identified by a reference vehicle for a given driving situation and for a given time context, the step of determining said database comprising the following steps of:
determining a value corresponding to the behavior of the vehicle identified in the given driving situation and in the given time context, said value being positive or negative;
determining an identifier associated with the identified vehicle by applying a cryptographic function to a license plate number associated with the identified vehicle;
transmitting a characterization of the driving behavior of the identified vehicle in the given situation and the given time context to the driving assistance server, the characterization comprising said value, the identifier associated with said identified vehicle, the given driving situation, and the given time context;
determining a driving behavior score associated with said identifier of the identified vehicle in the given situation and the given time context as a function of said value, said driving behavior score being determined;
by updating a driving behavior score already saved in the database in association with said identifier and said given driving situation, said already saved driving behavior score being added to said value and being thresholded by the zero value;
by creating a new record in said database if said value is positive and no driving behavior score associated with said identifier is saved in the database, with the driving behavior score associated with said identifier, in the given driving situation and the given time context, being equal to said value.

According to some embodiments, the given driving situation can be a driving situation identified from among a group comprising getting into a lane, and/or joining a highway, and/or joining a fast lane, and/or entering a roundabout.

The embodiments of the invention further provide a driving assistance system comprising a client vehicle and a driving assistance server, the system being characterized in that said client vehicle is configured for:
identifying a set of surrounding vehicles located in a neighboring area of the client vehicle in a current driving situation and a current time context, particularly defined by date and time information;
determining an identifier associated with each surrounding vehicle;
transmitting a request for characterizing the driving behavior of each surrounding vehicle to the driving assistance server, the characterization request comprising the identifier associated with each surrounding vehicle, the current driving situation, and the current time context;
receiving a driving behavior score associated with each identifier, said driving behavior score being determined by said driving assistance server 102 using a database of driving behavior scores;
determining a driving maneuver as a function of the driving behavior scores associated with the identifiers of said surrounding vehicles.

Advantageously, the embodiments of the invention allow the driving behavior of vehicles surrounding a client vehicle to be anticipated, which allows the client vehicle to perform an appropriate and safe maneuver that is compatible with the road traffic that is encountered.

Advantageously, the embodiments of the invention allow decision-making to be facilitated in the negotiation situations that are encountered by autonomous vehicles by providing the means for identifying vehicles liable to give way to the autonomous vehicle.

Advantageously, the embodiments of the invention allow efficient characterization of driving behavior by considering the characterization of the driving behavior of vehicles per driving situation and per time context, particularly defined by date and time information.

Advantageously, the embodiments of the invention allow information to be securely exchanged, allowing vehicles to be characterized using encryption of the license plate number of vehicles surrounding a client vehicle.

Advantageously, the embodiments of the invention allow uniquely positive characterization of the driving behavior of the set of vehicles using other vehicles and exploiting the characterization results in order to facilitate the decisions by client vehicles. The uniquely positive characterization of driving behavior enhances the reliability of the information, which is essential within an autonomous car context.

Advantageously, the embodiments of the invention allow negotiation cases that are difficult to manage by autonomous vehicles to be resolved, with the resulting maneuvers allowing the risks of collision to be reduced and helping to enhance the safety of road users.

### BRIEF DESCRIPTION OF THE DRAWINGS

Further features, details and advantages of the invention will become apparent upon reading the description, which is provided with reference to the accompanying drawings, which are provided by way of an example and which respectively show:

FIG. 1 is a diagram showing an example of an environment of an intelligent transport system, in which the driving assistance method and system can be implemented, according to some embodiments of the invention.

FIG. 2 is a flowchart showing a driving assistance method, according to some embodiments of the invention.

FIG. 3 is a flowchart showing a step of determining a database of driving behavior scores, according to some embodiments of the invention.

### DETAILED DESCRIPTION

The embodiments of the invention provide a driving assistance method and system for a client vehicle (a vehicle that requires driving assistance) upon detection of a current driving situation in a current time context, particularly defined by date and time information. The client vehicle is a connected vehicle operating in an intelligent transport system and requiring driving assistance from a driving assistance server.

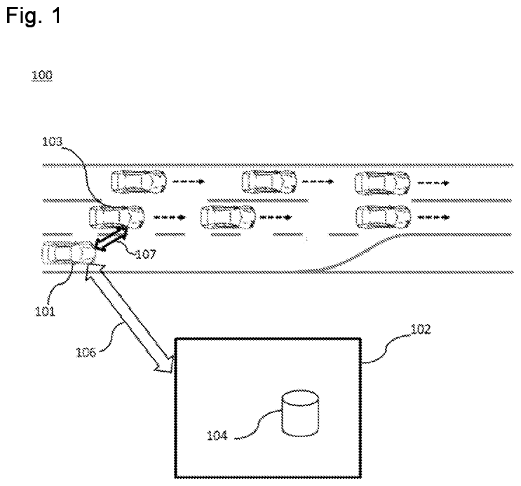

FIG. 1 shows an example of an environment of an intelligent transport system 100 according to some embodiments of the invention, in which the driving assistance method and system can be used to provide driving assistance to a client vehicle 101, with the client vehicle 101 communicating in the intelligent transport system 100 with a decision-making assistance server 102 via a wireless communication 106.

The intelligent transport system 100 can be used for various applications in the field of transport. The main fields of application of the intelligent transport system 100 comprise, without limitation:
road safety for assisting drivers and reducing the number of accidents and therefore the number of road accident victims, as well as material damages;
the mobility and efficiency of transport by providing drivers with data concerning the state of the transport system and traffic conditions for reducing travelling time and improving the reliability of the journey time;
information services and value-added comfort services by providing the driver and passengers with services allowing them to perform personal tasks when travelling.

According to some embodiments, the client vehicle 101 can comprise a set of functionalities and a set of on-board devices for implementing these functionalities. In particular, the client vehicle 101 can comprise processing and communication means, and sensor and human/machine interface technologies. The client vehicle 101 can be configured to process the information received from its environment and to exchange information in real time with the server 102 and/or at least one connected vehicle in the intelligent transport system 100.

According to some embodiments, the client vehicle 101 has sensors suitable for detecting vehicles, for recognizing their license plates and for detecting certain events, such as, for example, the activation of turn signals. In particular, the client vehicle 101 can have sensors and/or radar adapted to allow perception toward the front and/or toward the rear and/or on the sides.

According to some embodiments, the client vehicle 101 can have sensors comprising, without limitation, rain sensors and day/night sensors.

According to some embodiments, the data originating from the sensors on board the client vehicle 101 can include the speed (in the case of an on-board unit of a vehicle), the direction, the temperature, the state of the airbags, data originating from collision avoidance cameras, data from parking lot radar, data originating from ultrasonic transmitters/receivers, and the license plate numbers of vehicles surrounding the vehicle 101 in the intelligent transport system 100.

According to some embodiments, the communication means of the client vehicle 101 can include technologies with different features (for example, transmission rate, range, transmission power, frequency bands, etc.). The communication means can be equipped with one or more on-board transmitters/receivers for establishing one or more wireless links with other entities of the intelligent transport system 100; other vehicles, the server 102, roadside units, or control stations/centers. The communications between the client vehicle 101 and the entities of the intelligent transport system 100 can be direct or indirect (for example, via relay stations such as roadside units).

With reference to FIG. 1, the embodiments of the invention provide a driving assistance system comprising the client vehicle 101 and the driving assistance server 102, with the system being characterized in that the client vehicle 101 is configured for:
identifying a set of surrounding vehicles located in a neighboring area of the client vehicle 101 in a current driving situation and a current time context defined by date and time information;
determining an identifier associated with each surrounding vehicle by applying a cryptographic function to a license plate number associated with the surrounding vehicle;
transmitting a request for characterizing the driving behavior of each surrounding vehicle to the driving assistance server 102, the characterization request comprising the identifier associated with each surrounding vehicle, the current driving situation and the current time context;
receiving a driving behavior score associated with each identifier, the driving behavior score being determined by the driving assistance server 102 using a database of driving behavior scores, the database of driving behavior scores previously determined by the driving assistance server 102 comprising at least one strictly positive driving behavior score, with a driving behavior score being associated with an identifier associated with a vehicle, a given driving situation and a given time context;
determining a driving maneuver as a function of the driving behavior scores associated with the identifiers of the surrounding vehicles.

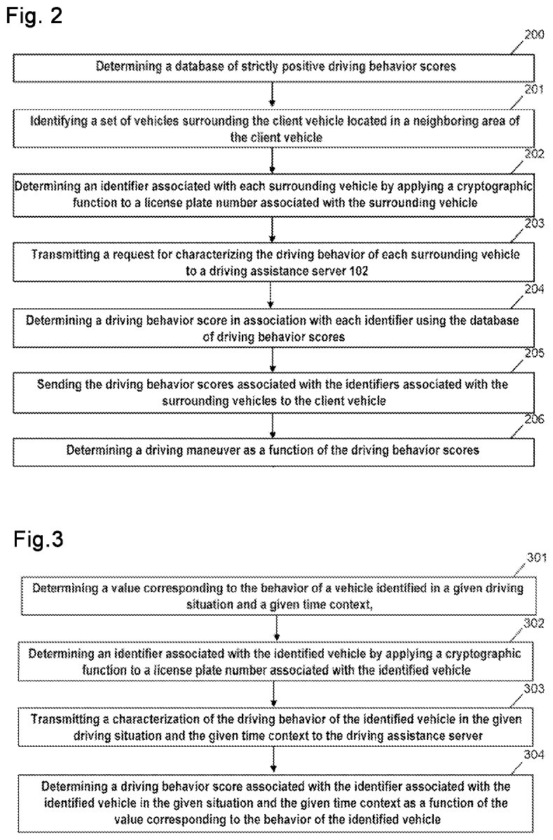

With reference to FIG. 2, the embodiments of the invention further provide a driving assistance method for a client vehicle upon detection of a current driving situation in a current time context, particularly defined by date and time information. The driving assistance method according to the embodiments of the invention allows the decision-making algorithms of the client vehicle 101 to be assisted so as to be able to anticipate the driving behavior of the vehicles surrounding the client vehicle 101 in the intelligent transport system 100. Anticipating the driving behavior of the vehicles surrounding the client vehicle 101 is based, according to the embodiments of the invention, on the construction of a database of driving behavior scores 104, which allows each vehicle identified in the intelligent transport system 100 to be associated with a strictly positive driving behavior score, which reflects the good behavior of the vehicle in a given situation and a given time context.

In step 200, a database 104 of strictly positive driving behavior scores can be determined, with a driving behavior score being associated with an identifier associated with an identified vehicle in a given driving situation and in a given time context, with the database being saved in the driving assistance server 102.

In step 201, a set of surrounding vehicles located in a neighboring area of the client vehicle 101 can be identified by the client vehicle 101 by identifying the numbers of the license plates of the surrounding vehicles.

In step 202, an identifier associated with each surrounding vehicle can be determined by the client vehicle 101 by applying a cryptographic function to a license plate number associated with each surrounding vehicle.

According to some embodiments, the cryptographic function can be a hash function.

In step 203, a request for characterizing the driving behavior of each surrounding vehicle can be transmitted from the client vehicle 101 to the driving assistance server 102, with the characterization request comprising the identifier associated with each surrounding vehicle determined in step 202, the current driving situation, and the current time context.

In step 204, a driving behavior score can be determined by the driving assistance server 102 in association with each identifier using the database of driving behavior scores.

More specifically, the step 204 of determining driving behavior scores can involve determining a driving behavior score in association with an identifier of an identified vehicle in the current situation and in the current time context, with step 204 comprising the steps of:
determining the driving behavior score associated with the identified vehicle as being the behavior score saved in the database 104 if a driving behavior score is associated therein with the identifier of the identified vehicle and with the current situation; and
associating a predefined value with the driving behavior score in association with the identifier of the identified vehicle if no driving behavior score is associated in the database 104 with said identifier and with the current driving situation.

The predefined value can be any value predefined by the driving assistance server 102 to designate undefined driving behavior that can correspond to poor driving behavior.

According to some embodiments, the step 204 can comprise determining the driving behavior score in association with an identifier associated with an identified vehicle while taking into account the current time context. In other words, step 204 can further comprise a step involving determining, if a behavior score associated with the identifier associated with the identified vehicle for a given driving situation corresponding to the current situation and for a given time context corresponding to the current time context, is already saved in the database 104 of driving behavior scores. This step advantageously allows the characterization of the driving behavior of the vehicles surrounding the client vehicle 101 to be refined.

In step 205, the driving behavior scores associated with the identifiers associated with the vehicles surrounding the client vehicle 101 can be transmitted from the driving assistance server 102 to the client vehicle 101.

In step 206, a driving maneuver can be determined by the client vehicle 101 as a function of the driving behavior scores associated with the identifiers relating to the vehicles surrounding the client vehicle 101.

According to some embodiments, the client vehicle 101 can be a connected vehicle having at least one vehicle-to-vehicle communication technology and the vehicles surrounding the client vehicle 101 can include at least one connected vehicle 103 having vehicle-to-vehicle communication technology and vehicle-to-infrastructure communication technology. According to these embodiments, the connected surrounding vehicle 103 can be configured to perform its self-characterization by means of a vehicle-to-infrastructure communication with the driving assistance server 102, and to send its driving behavior score received from the driving assistance server 102, to the client vehicle 101, by means of a vehicle-to-vehicle communication.

According to these embodiments, the method can further comprise a step of self-characterizing the surrounding vehicle 103 (not shown in FIG. 2) for determining a driving behavior score in association with an identifier associated with the surrounding vehicle 103, with the step comprising the sub-steps of:
determining, by the surrounding vehicle 103, an identifier associated with the surrounding vehicle 103 by applying a cryptographic function to a license plate number associated with the surrounding vehicle 103;
transmitting, from the surrounding vehicle 103 to the driving assistance server 102, a request for characterizing the driving behavior of the surrounding vehicle 103 (a self-characterizing request), the characterization request comprising the identifier associated with the surrounding vehicle 103, the current situation and the current time context;
determining, by the driving assistance server 102, a driving behavior score associated with the surrounding vehicle 103 using the database 103 of driving behavior scores.

More specifically, the step of determining the driving behavior score associated with the surrounding vehicle 103 can involve performing the steps of:
determining whether a driving behavior score, associated with the identifier associated with the surrounding vehicle 103, in a given driving situation corresponding to the current situation, is saved in the database 104 of driving behavior scores;
determining the driving behavior score as being the behavior score saved in the database 104 if a driving behavior score associated with the identifier associated with the surrounding vehicle 103 in the current situation is saved in the database 104;
associating a predefined value with the driving behavior score if no driving behavior score associated with the identifier associated with the surrounding vehicle 103 and in a given driving situation corresponding to the current driving situation is saved in the database 104 of driving behavior scores.

According to some embodiments, the step of self-characterizing the surrounding vehicle 103 can include determining the driving behavior score in association with the identifier associated with the surrounding vehicle 103, taking into account the current time context. In other words, the step of self-characterizing the surrounding vehicle 103 can further comprise a step involving determining whether a behavior score, associated with the identifier associated with the surrounding vehicle 101, in a given driving situation corresponding to the current situation and in a given time context corresponding to the current time context, is already saved in the database 104 of driving behavior scores. This step advantageously allows the characterization of the driving behavior of the surrounding vehicle 103 to be refined.

According to some embodiments, the method can further comprise a step (not shown in FIG. 2) for transmitting, from the surrounding vehicle 103 to the client vehicle 101 and to neighboring vehicles in the intelligent transport system 100, the driving behavior score associated with the identifier of the surrounding vehicle 103 if said score is different from the predefined value.

FIG. 3 is a flowchart showing the step 200 of determining the database 104 of driving behavior scores according to some embodiments of the invention. The database 104 comprises at least one driving behavior score associated with an identifier associated with a vehicle identified by a reference vehicle in a given driving situation and a given time context.

According to some embodiments, the reference vehicle has sensors suitable for detecting vehicles, for recognizing their license plates and for detecting certain events such as, for example, the activation of turn signals. In particular, the reference vehicle can have sensors and/or radar adapted to allow perception toward the front and/or toward the rear and/or on the sides. According to some embodiments, the reference vehicle can also have sensors comprising, without limitation, rain sensors and day/night sensors.

In step 301, a value corresponding to the behavior of the vehicle identified in the given situation and in the given time context can be determined by the reference vehicle, with the value being positive or negative. A positive value indicates good driving behavior (for example, the systematic activation of a turn signal for entering and/or exiting a roundabout) and a negative value indicates poor driving behavior (for example, forced passage, repeated braking, no turn signal, a short safety distance, traffic in the left lane on a highway).

According to some embodiments, a given observed situation can be a negotiation situation observed by a reference vehicle that can be an autonomous or non-autonomous vehicle (manually controlled by a driver) having sensors and/or appropriate driving assistance technologies, a negotiation situation that can correspond, for example, to getting into a lane, or entering a roundabout. For example, when the reference vehicle gets into a lane, it can be configured to detect and memorize that a vehicle gave way by determining a positive value for the behavior of this vehicle. In another example, when the reference vehicle intends to enter a full roundabout and a vehicle in the roundabout gives way, the reference vehicle can determine a positive value corresponding to this vehicle. In another example, when the vehicle in front of the reference vehicle systematically activates the turn signal to enter and/or exit a roundabout, the reference vehicle can determine a positive value for this vehicle.

In step 302, an identifier associated with the identified vehicle by the reference vehicle can be determined by the reference vehicle by applying a cryptographic function to a license plate number associated with the identified vehicle.

In step 303, a characterization of the driving behavior of the identified vehicle in the given situation and the given time context can be transmitted from the reference vehicle to a driving assistance server 102, with the characterization comprising the value determined in step 301, the identifier associated with the identified vehicle determined in step 302, the given driving situation, and the given time context. Positive values are used to increase the driving behavior scores for a given driving situation and for a given vehicle identified by the identifier determined from the number of its license plate.

In the determining step 304, a driving behavior score associated with the identifier associated with the identified vehicle in the given situation and the given time context can be determined by the driving assistance server 102 as a function of the value, with the driving behavior score being determined:
by updating a driving behavior score already saved in the database 104 in association with the identifier associated with the identified vehicle and with the given driving situation, with the already saved driving behavior score being added to the value and being thresholded by the zero value;
by creating a new record in the database 104 if the value corresponding to the behavior of the identified vehicle in the given situation and in the given time context is positive and no driving behavior score associated with the identifier associated with the identified vehicle is saved in the database 104, with the driving behavior score associated with the identifier associated with the identified vehicle by the reference vehicle, in the given driving situation and the given time context, being equal to the value corresponding to the behavior of the vehicle determined in step 301.

According to some embodiments, the technology used to ensure communication between the various entities in the intelligent transport system 100 comprising the vehicle-to-vehicle communication between the client vehicle 101 and at least one vehicle 103 and the vehicle-to-infrastructure communication between the client vehicle 101 and the driving assistance server 102 can be selected from a group comprising, by way of a non-limiting example, ITS-G5 technology, any wireless access technology derived from cellular networks (for example, the 2G, 3G, 4G, LTE, LTE-V2X, the next generation 5G networks), Li-Fi (‘Light Fidelity’) technology using light as a data transmission medium, and satellite networks. ITS-G5 technology can be hybridized with cellular networks. Wireless access technologies can also include short-range access technologies, ad-hoc access technologies (for example, the 5 GHz WLAN standard, the 5.9 GHz ITS standard, and the Wi-Fi™ standard), high-speed wireless access technologies (for example, WiMax technology), digital broadband, infra-red technologies, and sensor networks.

According to some embodiments, a driving situation can be a driving situation identified from among a group comprising getting into a lane, and/or joining a highway, and/or joining a fast lane, and/or entering a roundabout.

According to some embodiments, the time context can be used to correlate, if the driving situation occurs at a time that normally experiences heavy traffic, with a data item that corresponds to a public holiday or a Saturday or a Sunday or to a school vacation period. The time can also determine a day or night context, which can also be obtained by a day/night sensor.

The invention is not limited to the embodiments described above by way of a non-limiting example. It encompasses all the alternative embodiments that can be contemplated by a person skilled in the art.

In general, the routines executed to implement the embodiments of the invention, whether they are implemented within the context of an operating system or of a specific application, of a component, of a program, of an object, a module or a sequence of instructions, or even a subset thereof, can be referred to as “computer program code” or simply “program code”. Program code typically includes computer-readable instructions that reside at various times in various memory and storage devices in a computer and which, when they are read and executed by one or more processor(s) in a computer, cause the computer to perform the operations needed to execute the operations and/or elements specific to the various aspects of the embodiments of the invention. The instructions of a computer-readable program, for carrying out the operations of the embodiments of the invention can be, for example, the assembly language, or even a source code or an object code written in combination with one or more programming language(s).

1-9. (canceled)

10. A method for assisting with driving a client vehicle upon detection of a current driving situation in a current time context, the method comprising:
identifying a set of surrounding vehicles located in a neighboring area of said client vehicle;
determining an identifier associated with each surrounding vehicle;
transmitting a request for characterizing the driving behavior of each surrounding vehicle to a driving assistance server, said characterization request comprising the identifier associated with each surrounding vehicle, the current driving situation, and the current time context;
determining a driving behavior score in association with each identifier using a database of driving behavior scores, with each driving behavior score in the database being associated with a vehicle identifier, in a given driving situation and in a given time context; and
determining a driving maneuver as a function of the driving behavior scores associated with the identifiers of said surrounding vehicles.

11. The method as claimed in claim 10, wherein said identifier associated with each surrounding vehicle is determined by applying a cryptographic function to a license plate number associated with said surrounding vehicle.

12. The method as claimed in claim 10, wherein said database of driving behavior scores comprises at least one strictly positive driving behavior score, the determining the driving behavior score comprising:
determining said driving behavior score as being the behavior score saved in said database when a driving behavior score is associated therein with said identifier of said surrounding vehicle and with the current driving situation; and
associating a predefined value with said driving behavior score when no driving behavior score is associated in the database with said identifier and with the current driving situation.

13. The method as claimed in claim 10, wherein the client vehicle is a connected vehicle having vehicle-to-vehicle communication technology and the set of surrounding vehicles comprises at least one connected surrounding vehicle having vehicle-to-vehicle communication technology and vehicle-to-infrastructure communication technology, the method comprising transmitting, by said at least one connected surrounding vehicle to said client vehicle, a driving behavior score of said connected surrounding vehicle with a value different from said predefined value, using vehicle-to-vehicle communication.

14. The method as claimed in claim 13, further comprising self-characterizing said connected surrounding vehicle in order to determine said driving behavior score in association with an identifier of said connected surrounding vehicle, the self-characterizing comprising:
determining an identifier associated with the connected surrounding vehicle by applying a cryptographic function to a license plate number associated with the connected surrounding vehicle;
transmitting a request for characterizing the driving behavior of said connected surrounding vehicle to the driving assistance server, said characterization request comprising the identifier associated with the connected surrounding vehicle, said current situation and said current time context; and
determining a driving behavior score associated with said connected surrounding vehicle using said database.

15. The method as claimed in claim 14, wherein the determining the driving behavior score associated with said connected surrounding vehicle comprising:
determining said driving behavior score as being the behavior score saved in said database when a driving behavior score is associated therein with said identifier of said connected surrounding vehicle and with the current situation; and
associating a predefined value with said driving behavior score when no driving behavior score is associated in the database with said identifier and with the current driving situation.

16. The method as claimed in claim 10, further comprising, prior to the identifying the set of surrounding vehicles, determining said database, said database of driving behavior scores comprising at least one driving behavior score associated with an identifier relating to a vehicle identified by a reference vehicle for a given driving situation and for a given time context, the determining said database comprising:
determining a value corresponding to the behavior of the vehicle identified in said given driving situation and in the given time context, said value being positive or negative;
determining an identifier associated with said identified vehicle by applying a cryptographic function to a license plate number associated with said identified vehicle;
transmitting a characterization of the driving behavior of said identified vehicle in said given situation and the given time context to said driving assistance server, said characterization comprising said value, the identifier associated with said identified vehicle, the given driving situation, and the given time context; and
determining a driving behavior score associated with said identifier associated with said identified vehicle in the given situation and the given time context as a function of said value, said driving behavior score being determined:
by updating a driving behavior score already saved in the database in association with said identifier and said given driving situation, said already saved driving behavior score being added to said value and being thresholded by the zero value; and
by creating a new record in said database when said value is positive and no driving behavior score associated with said identifier is saved in the database, with the driving behavior score associated with said identifier, in the given driving situation and the given time context, being equal to said value.

17. The method as claimed in claim 10, wherein said given driving situation is a driving situation identified from among a group comprising getting into a lane, and/or joining a highway, and/or joining a fast lane, and/or entering a roundabout.

18. The method as claimed in claim 10, wherein said current time context is defined by date and time information.

19. A driving assistance system comprising:
a client vehicle and a driving assistance server, wherein said client vehicle is configured to:
identify a set of surrounding vehicles located in a neighboring area of said client vehicle in a current driving situation and a current time context;
determine an identifier associated with each surrounding vehicle;
transmit a request for characterizing the driving behavior of each surrounding vehicle to said driving assistance server, said characterization request comprising the identifier associated with each surrounding vehicle, the current driving situation, and the current time context;
receive a driving behavior score associated with each identifier, said driving behavior score being determined by said driving assistance server using a database of driving behavior scores; and
determine a driving maneuver as a function of the driving behavior scores associated with the identifiers of said surrounding vehicles.

20. The system as claimed in claim 19, wherein said current time context is defined by date and time information.
